(19) United States
(12) Patent Application Publication
(10) Pub. No.: US 2010/0187395 A1
(43) Pub. Date: Jul. 29, 2010

(54) Rotating work platform for whell chair bound people

(76) Inventor: Ronald Jeffrey Callahan, Poughkeepsie, NY (US)

Correspondence Address: R. Jeffrey Callahan, 29 Wendy Drive, Poughkeepsie, NY, 12603, US

(21) Appl. No.: 12/322,152

(22) Filed: Jan. 29, 2009

(51) Int. Cl. F16M 11/08

(52) U.S. Cl. 248/349.1

(57) ABSTRACT

To enable a wheel chair bound person to rotate 360 degrees to more easily position themselves to a desired position, either at a work station, entering or exiting a transport vehicle, hunting platform or anywhere a wheel chair bound person has to position themselves in a 360 radius.

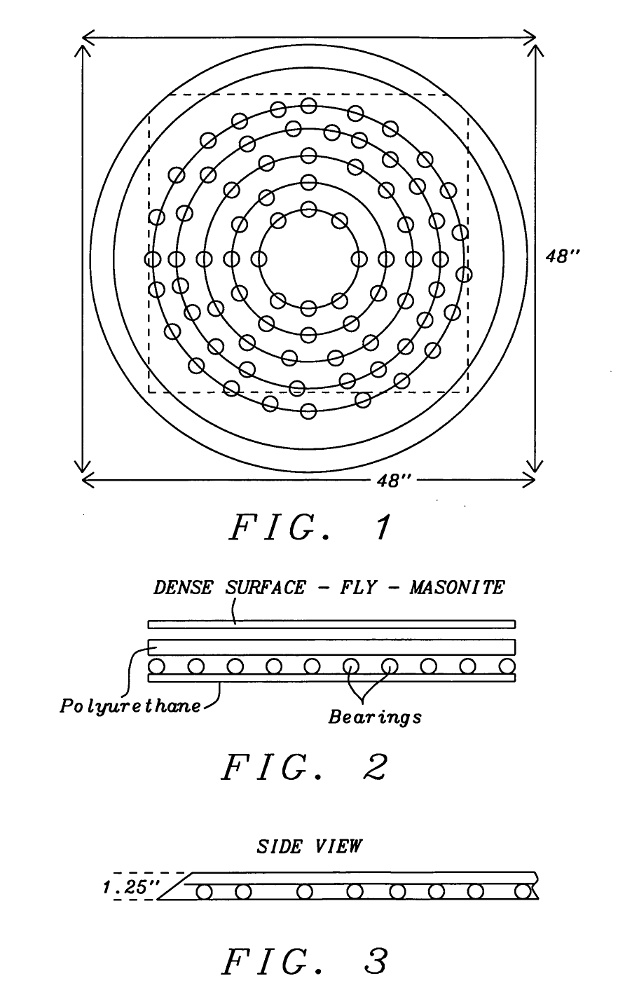

The present invention relates to a rotating work platform for wheel chair bound people.

This device is comprised of the following components:
(1) Bottom platform.
(2) Ball bearings or other non friction material to allow the rotation or movement at any angle.
(3) Top platform to fit over rotating material, be ball bearings or other non-friction material.
(4) A top surface fit to the size of rotating platform to distribute weight of wheel chair so chair does not cause an indent in material used to construct platform

By sandwiching ball bearings between bottom and second platform you are able to rotate this configuration in a 360 degree area to allow the wheelchair bound person access to any angle that is necessary to position them selves for the purpose of working at a work station, entering or exiting a transport vehicle, hunting platform or any area that would make it easier to access a 360 radius their could be many different materials used. Configurations of the bearings could be any number of configurations to allow different angles of movement.

Could be used to position a number of commodities, be it material or people, or platforms in trucks or vans to enable access to items placed or removal of said items.

What is claimed is:

1. Two pieces of polyurethane or other non friction material, with ball bearings set in the bottom platform in descending circles, starting from the outside to the center, the top surface is placed on the bottom surface with the ball bearing in place. on top of this configuration an other solid platform would be placed to help distribute the weight of the wheel chair, so it does not sink in to the soft material used to rotate. This whole configuration should be at a height that would allow the wheel chair bound person to mount and dismount the platform easily. this rotating platform can be in various sizes, depending on the needed use, be it a work station, or a system mounted in a transport vehicle to allow user to more easily position themselves to lock up for transport, or a hunting platform to be able to reposition themselves to view a different section of terrain. This system can have a variety of configurations to allow a wheel chair bound person to reposition themselves either by an aid person or if they have the use of their arms use a grab bar or their chair controls to position themselves.
